(19) United States
(12) Patent Application Publication
(10) Pub. No.: US 2023/0274337 A1
(43) Pub. Date: Aug. 31, 2023

(54) METHOD FOR SUPPORTING ONLINE PURCHASE OF PRODUCT DISPLAYED AT OFFLINE LOCATION, AND MANAGEMENT SERVER USED THEREFOR

(71) Applicant: Hyun Jung CHUN, Seoul (KR)

(72) Inventor: Hyun Jung CHUN, Seoul (KR)

(21) Appl. No.: 18/017,218

(22) PCT Filed: May 20, 2021
(86) PCT No.: PCT/KR2021/006267

§ 371 Date: Jan. 20, 2023

(30) Foreign Application Priority Data
Jul. 20, 2020 (KR) 10-2020-0089432

(51) Int. Cl. G06Q 30/0601; G06Q 30/02

(52) U.S. Cl. CPC G06Q 30/0639; G06Q 30/0281; G06Q 30/0627

(57) ABSTRACT

A method for supporting online purchase of a product displayed at an offline location and a management server used therefore are proposed. An embodiment is implemented by a management server through the processes of: receiving identification information of a product displayed at the offline location from a user terminal possessed by a user who visits an offline location store; searching for a seller server operated by a seller who sells the product displayed at the offline location based on the product identification information received from the user terminal; and transmitting a delivery request including the product identification information to the searched seller server. According to the embodiment, a user who wants to purchase a product displayed at an offline location right away online can immediately receive support for the online purchase of the product by reading identification information of the product through the user terminal..

### TECHNICAL FIELD

The present invention relates to a method for supporting online purchase of a product displayed at an offline location and a management server used therefore, and more particularly, to a method for supporting online purchase of a product displayed at an offline location, which allows a user who wants to purchase a product displayed at an offline location right away online to immediately receive support for the online purchase of the product by reading identification information of the product through a user terminal, and a management server used for the method.

### BACKGROUND ART

As the size of an online advertising market grows significantly with the rapid spread of smartphones, the size of the online advertising market in Korea is expected to exceed the size of a traditional offline advertising market in the near future.

Meanwhile, various advertising technologies are being tried in the offline advertising market as well. Recently, an offline advertising method in which products to be advertised are directly displayed in a specific most visited offline space is widely entrenched.

Specifically, an advertising method in which various products that may be of interest to visitors, such as cosmetics, are displayed in a specific offline location where visitors stay for a long time, such as a beauty salon, etc., is widely used.

Meanwhile, in online advertisements, URLs of sites that support the online purchase of products have long been linked to online advertisement contents, thereby inducing users exposed to the online advertisement contents to easily purchase the products online. On the other hand, in order for a user exposed to an advertisement product displayed in an offline space to purchase the product online, he or she should separately search for the product through an Internet shopping mall.

As described above, a method of product advertisement in which products are directly displayed at an offline location may provide advertising effects that cannot be provided in online advertisements, such as a direct experience effect of the user. On the other hand, when a user intends to directly purchase the product online, there is a limit in that it cannot directly support the user’ purchase of the online product, as in the online advertisement.

### SUMMARY OF INVENTION

### Problems to Be Solved by Invention

Accordingly, it is an object of the present invention to provide a method for supporting online purchase of a product displayed at an offline location, which allows a user who wants to purchase a product displayed at an offline location right away online to immediately receive support for the online purchase of the product by reading identification information of the product through a user terminal, and a management server used for the method.

### Means for Solving Problems

According to another aspect of the present invention, there is provided a management server including: a reception unit configured to receive identification information of a product displayed at an offline location from a user terminal possessed by a user who visits an offline location store; a determination unit configured to search for a seller server operated by a seller who sells the product displayed at the offline location based on the product identification information received from the user terminal; and a transmission unit configured to transmit a delivery request including the product identification information to the searched seller server.

Preferably, the delivery request includes delivery address information input to the user terminal by the user.

Meanwhile, according to another aspect of the present invention, there is provided a management server including: a reception unit configured to receive identification information of a product displayed at the offline location from a user terminal possessed by a user who visits an offline location store; a determination unit configured to search for a seller server which sells the product displayed at the offline location based on the product identification information received from the user terminal; and a transmission unit configured to transmit a delivery request including the product identification information to the searched seller server.

Preferably, the delivery request includes delivery address information input by the user to the user terminal.

### Advantageous Effects

According to the present invention, a user who wants to purchase a product displayed at an offline location right away online can immediately receive support for the online purchase of the product by reading identification information of the product through the user terminal.

### BRIEF DESCRIPTION OF DRAWINGS

FIG. 1 is a view illustrating a configuration of a purchase support system for products displayed at an offline location according to an embodiment of the present invention.

FIG. 2 is a functional block diagram illustrating a structure of a management server which provides a purchase support service for products displayed at an offline location according to an embodiment of the present invention.

FIG. 3 is a flow chart illustrating signals in an execution process of a method for supporting purchase of a product displayed at the offline location according to an embodiment of the present invention.

### MODE FOR CARRYING OUT INVENTION

Hereinafter, the present invention will be described with reference to the accompanying drawings in detail. Referring to the drawings, wherein like reference characters designate like or corresponding parts throughout the several views. In the embodiments of the present invention, the publicly known functions and configurations that are judged to be able to make the purport of the present invention unnecessarily obscure will not be described.

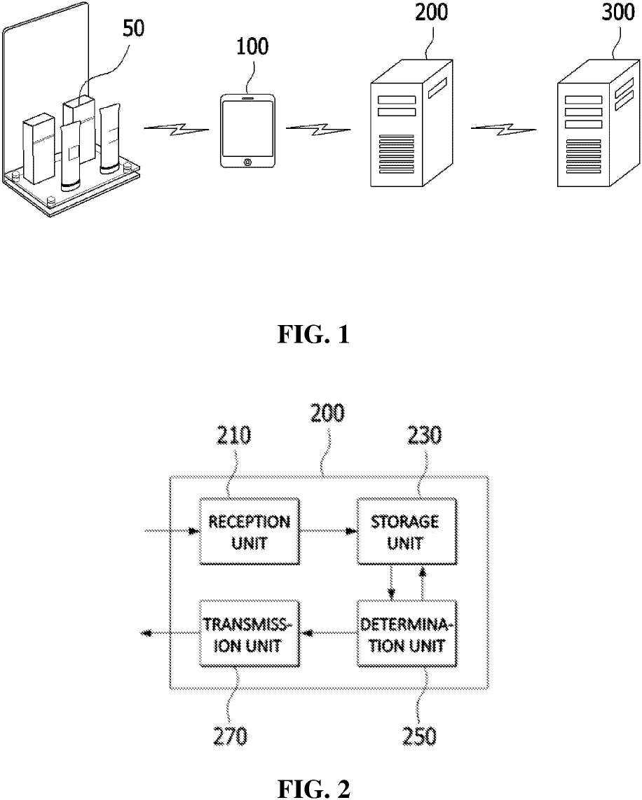

FIG. 1 is a view illustrating a configuration of a purchase support system for products displayed at an offline location according to an embodiment of the present invention. Referring to FIG. 1, an online purchase support system for products displayed at an offline location according to an embodiment of the present invention includes a user terminal 100, a management server 200 and a seller server 300.

The user terminal 100 is a wireless communication terminal such as a smartphone possessed by a user who uses the service according to the present invention. In carrying out the present invention, it is preferable that a predetermined application program distributed by a provider who provides a purchase support service for products displayed at the offline location according to an embodiment of the present invention is installed in the user terminal 100.

The management server 200 is a server installed and operated by the provider who provides the purchase support service for products displayed at the offline location according to an embodiment of the present invention. The management server 200 is configured to: receive identification information of products 50 displayed at the offline location from the user terminal 100; search for the seller server 300 operated by a seller who sells the products 50 displayed at the offline location online based on the product identification information received from the user terminal 100; and transmit a delivery request including the product identification information to the searched seller server 300.

The seller server 300 is a server installed and operated by an online store operator who sells the products 50 displayed at the offline location online. The seller server 300 is configured to: receive a product delivery-related information request from the management server 200; inquire product information such as an inventory quantity, price information and an available date of the product based on the product identification information included in the product delivery-related information request; and transmit the inquired product information to the management server 200 as the product delivery-related information.

FIG. 2 is a functional block diagram illustrating a structure of the management server 200 which provides the purchase support service for products displayed at an offline location according to an embodiment of the present invention. Referring to FIG. 2, the management server 200 which provides the purchase support service for products displayed at the offline location according to an embodiment of the present invention includes a reception unit 210, a storage unit 230, a determination unit 250 and a transmission unit 270.

The reception unit 210 of the management server 200 is configured to: receive a product information provision request and a product delivery request from the user terminal 100; and receive the product delivery-related information from the seller server 300.

The determination unit 250 of the management server 200 is configured to: search for information of a seller who sells the product based on the product identification information included in the product information provision request received from the user terminal 100; determine whether the product can be delivered based on the product delivery-related information received from the seller server 300; and search for product information similar to the product if it is determined that delivery of the product is impossible.

The transmission unit 270 of the management server 200 is configured to: transmit the product delivery-related information request to the seller server 300; transmit the product information selected by the user to the user terminal 100; and transmit the product delivery request to the seller server 300.

Meanwhile, the storage unit 230 of the management server 200 is configured to: store seller information such as URL information of the seller server 300 operated by each of sellers who sell various products online together with identification information of products sold by the sellers, product type information, and product price information etc.; and store various received information from the reception unit 210, various search information and determination information from the determination unit 250, and various transmission information from the transmission unit 270 in real time.

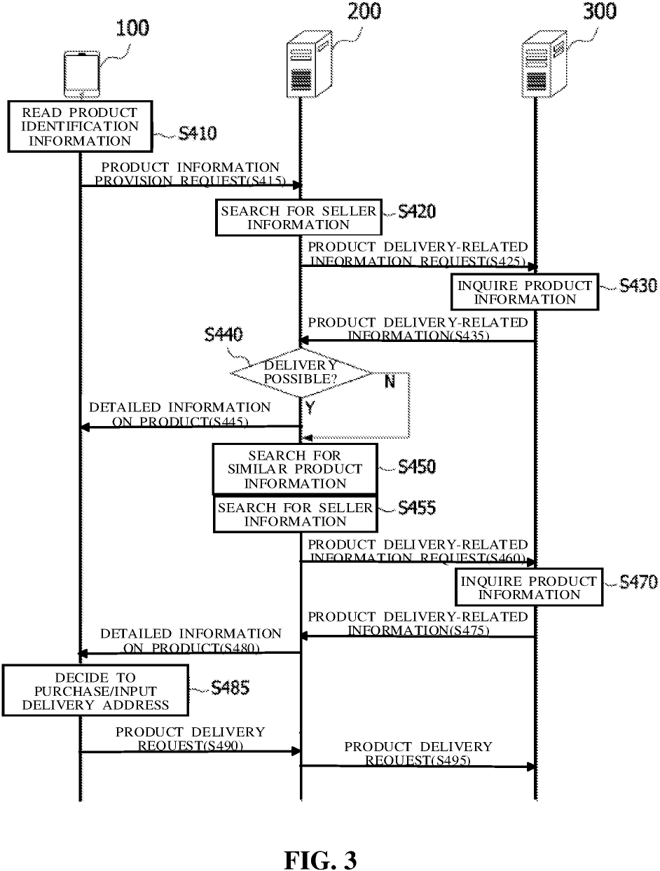

FIG. 3 is a flow chart illustrating signals in an execution process of a method for supporting purchase of a product displayed at the offline location according to an embodiment of the present invention. Hereinafter, the execution process of the method for supporting the purchase of a product displayed at an offline location according to an embodiment of the present invention will be described with reference to FIGS. 1 to 3.

First, when a user who has visited an offline location such as a beauty salon and experienced a displayed product 50 such as cosmetics displayed at the location wants to purchase the product 50 online, the user executes the predetermined application installed in the user terminal 100.

When the user captures a QR code attached to the product 50 through a camera module provided in the user terminal 100 while the application program is executing, the application program reads product identification information from the captured image of the QR code (S410).

Then, the application program generates a product information provision request including the product identification information, and the user terminal 100 transmits the product information provision request to the management server 200 (S415).

When the reception unit 210 of the management server 200 receives the product information provision request from the user terminal 100, the determination unit 250 of the management server 200 searches for information on a seller who sells the product corresponding to the product identification information included in the product information provision request (S420).

Meanwhile, in carrying out the present invention, it is preferable that the storage unit 230 of the management server 200 stores the seller information such as URL information of the seller server 300 operated by each of sellers who sell various products online together with the identification information of products sold by the sellers, product type information, and product price information etc.

The determination unit 250 of the management server 200 generates a product delivery-related information request including the product identification information included in the product information provision request received from the user terminal 100, and the transmission unit 270 of the management server 200 transmits the product delivery-related information request generated as described above to the seller server 300 searched in the above-described step S420 (S425).

Then, the seller server 300 inquires product information such as an inventory quantity of the product based on the product identification information included in the product delivery-related information request received from the management server 200 (S430), and transmits the product delivery-related information including the inquired product information to the management server 200 (S435).

Meanwhile, in carrying out the present invention, it is preferable that the seller server 300 stores inventory quantity information of each product together with identification information of each product sold by the seller online, and the inventory quantity information of the product is updated in real time to be stored and managed.

In addition, in carrying out the present invention, it is preferable that the product delivery-related information received by the management server 200 from the seller server 300 in the above-described step S435 is information related to the identification information of the product, and is cumulatively stored in the storage unit 230 of the management server 200 together with the information of the seller server 300, such that the inventory quantity information of each product by seller is also updated in the management server 200 in real time to be stored and managed.

Meanwhile, the determination unit 250 of the management server 200 determines whether the product selected by the user can be delivered based on product information such as the inventory quantity of the product received from the seller server 300 (S440).

Specifically, when the inventory quantity information received from the seller server 300 is a predetermined reference value (e.g., two (2)) or more, the determination unit 250 of the management server 200 may determine that delivery of the product is possible.

As such, when it is determined that the product can be delivered, the determination unit 250 of the management server 200 searches for detailed information on the product such as a detailed image of the product stored in the storage unit 230, and transmits the detailed information on the searched product to the user terminal 100 (S445).

Meanwhile, in the above-described step S440, if the inventory quantity information received from the seller server 300 is less than the predetermined reference value (e.g., two (2)), the determination unit 250 of the management server 200 may determine that delivery of the product is impossible.

In this case, the determination unit 250 of the management server 200 may search for a product similar to the product corresponding to the product identification information included in the product information provision request in the above-described step S415 through various product information stored in the storage unit 230 (S450).

Specifically, the determination unit 250 of the management server 200 has the same product type information as the product selected by the user in the above-described step S410, and may primarily search for identification information of products having a price within a predetermined error range (e.g., 10%) compared to the product selected by the user.

Meanwhile, in carrying out the present invention, it is preferable that the determination unit 250 of the management server 200 secondarily searches for product identification information in which the inventory quantity information received from the product seller server 300 and stored in association with the product identification information is the predetermined reference value or more (e.g., five (5)) among the primarily searched product identification information, thus to finally search for identification information of products having sufficient inventory quantity.

Next, the determination unit 250 of the management server 200 searches for seller information such as URL information of the seller server 300 operated by a seller who sells the product searched in the above-described step S450 online (S455).

The determination unit 250 of the management server 200 generates a product delivery-related information request including the product identification information finally searched in the above-described step S450, and the transmission unit 270 of the management server 200 transmits the product delivery-related information request generated as described above to the seller server 300 searched in the above-described step S455 (S460).

Then, the seller server 300 inquires the product information such as the inventory quantity of the product based on the product identification information included in the product delivery-related information request received from the management server 200 (S470), and transmits the product delivery-related information including the inquired product information to the management server 200 (S475).

The determination unit 250 of the management server 200 determines that the product can be delivered when the inventory quantity information of the product received from the seller server 300 is the predetermined reference value (e.g., two (2)) or more, searches for detailed information on the product such as a detailed image of the product stored in the storage unit 230, and transmits the detailed information on the searched product to the user terminal 100 (S480).

Thereby, the user who has confirmed the detailed information on the product through the user terminal 100 decides to purchase the product, and then inputs a product delivery address into the user terminal 100 (S485).

Thereafter, when the user pays for the product price and shipping cost through the user terminal 100, the management server 200 receives a product delivery request including the product delivery address and product identification information from the user terminal 100 (S490).

Then, the determination unit 250 of the management server 200 transmits a product delivery request including the product delivery address and product identification information to the searched seller server 300 based on the product identification information included in the product delivery request (S495).

Thereby, when the seller server 300 receives the product delivery request from the management server 200, the seller delivers the product to the product delivery address included in the product delivery request. Meanwhile, the seller server 300 updates and stores the inventory quantity information of the product by subtracting the inventory quantity information as much as the delivery quantity.

Meanwhile, in carrying out the present invention, when a plurality of seller information is searched in the above-described step S420, the management server 200 may transmit the product delivery-related information request to each of a plurality of seller servers 300 (S425).

In this case, in the above-described step S435, the plurality of seller servers 300 may transmit product delivery-related information, which includes the produce inventory quantity, the product available date, the product sales price, and product sales agency fee information paid to the operator of the management server 200 when selling the product, to the management server 200.

In addition, the product delivery-related information received by the management server 200 from each seller server 300 is information related to the identification information of the product, and may be cumulatively stored together with the information of the seller server 300 in the storage unit 230 of the management server 200.

Meanwhile, in this case, the determination unit 250 of the management server 200 determines a seller server 300, which has transmitted the earliest product available date among the plurality of seller servers 300, as the seller server 300 to transmit the product delivery request in the above-described step S495, thereby it is possible to make product delivery more rapid.

In addition, the determination unit 250 of the management server 200 determines a seller server 300, which has transmitted the lowest product selling price among the plurality of seller servers 300, as the seller server 300 to transmit the product delivery request in the above-described step S495, thereby it is possible to reduce product purchase costs of the user.

Further, the determination unit 250 of the management server 200 determines a seller server 300, which has transmitted the highest product sales agency fee among the plurality of seller servers 300 as the seller server 300 to transmit the product delivery request in the above-described step S495, thereby it is possible to maximize operating margins of the management server 200.

In addition, the terminology used herein is for the purpose of describing particular embodiments only and is not intended to limit the present invention thereto. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

While the present invention has been described with reference to the preferred embodiments and modified examples, the present invention is not limited to the above-described specific embodiments and the modified examples, and it will be understood by those skilled in the related art that various modifications and variations may be made therein without departing from the scope of the present invention as defined by the appended claims, as well as these modifications and variations should not be understood separately from the technical spirit and prospect of the present invention.

### INDUSTRIAL APPLICABILITY

The present invention may be applied to the electronic commerce technology fields, such that industrial applicability thereof may be recognized.

1. A method for supporting online purchase of a product displayed at an offline location, the method comprising:
(a) receiving, by a management server, identification information of a product displayed at the offline location from a user terminal possessed by a user who visits an offline location store;
(b) searching for, by the management server, a seller server operated by a seller who sells the product displayed at the offline location based on the product identification information received from the user terminal; and
(c) transmitting, by the management server, a delivery request including the product identification information to the searched seller server.

2. The method according to claim 1, wherein the delivery request includes delivery address information input to the user terminal by the user.

3. A management server comprising:
a reception unit configured to receive identification information of a product displayed at an offline location from a user terminal possessed by a user who visits an offline location store;
a determination unit configured to search for a seller server operated by a seller who sells the product displayed at the offline location based on the product identification information received from the user terminal; and
a transmission unit configured to transmit a delivery request including the product identification information to the searched seller server.

4. The management server according to claim 3, wherein the delivery request includes delivery address information input to the user terminal by the user.
